(19) United States
(12) Patent Application Publication
(10) Pub. No.: US 2004/0134862 A1
(43) Pub. Date: Jul. 15, 2004

(54) Device and method for tertiary treatment of wastewater and other contaminated aqueous media (CAM)

(76) Inventor: Bernard Greenberg, Brooklyn, NY (US)

Correspondence Address: GOTTLIEB RACKMAN & REISMAN PC, 270 MADISON AVENUE, 8TH FLOOR, NEW YORK, NY, 100160601

(21) Appl. No.: 10/674,887

(22) Filed: Sep. 30, 2003

Related U.S. Application Data
(60) Provisional application No. 60/415,197, filed on Oct. 1, 2002.

(51) Int. Cl. C02F 1/46

(52) U.S. Cl. 210/748

(57) ABSTRACT

A method and apparatus for treating settled, unfiltered effluent out of the secondary (aeration) stage of wastewater treatment facilities are disclosed. Designed principally for the denitrification, phosphorous removal, and exhaustive disinfection of the liquid phase after the secondary treatment of wastewater, all this in a single step and without chemical addition. Since no chemical agents are employed, (alkaline earth carbonates are considered a normal constituent of the water) the method is particularly applicable to the purification of drinking water supplies. The method and apparatus achieve high degrees of purification, thereby laying the basis for the reuse of wastewater so treated. Bio-solids are also disinfected and made filterable. Preferred and particularly advantageous embodiments bf the system are disclosed.

### BACKGROUND OF THE INVENTION

The invention relates to a novel electrolytic device, filtration system, and method for separating selected pollutional components from wastewater and other contaminated aqueous media (CAM).

Many systems have been used in the treatment of sanitary wastewater and other CAM.

Those in common use rely on in at least one stage of their operation, aerated biological treatment of the liquid phase. This process is susceptible to disturbances in liquid flow, nutrient loadings, temperature, chemical content, and other influences. Close supervision of the process by skilled operators is usually required, though such supervision is no guarantee of sought-after outcome. Importantly, ammonia nitrogen is not removed, only transformed into nitrates, nor are phosphates removed. Bacteria, along with other colloidal organic matter, are carried over from this step and then present an infectious potential to receiving waters. Sludge produced in this process carries daunting disposition problems, this owing to its high water content, infectious potential, and its ability to retain toxic substances.

Proper management of aerated biologic treatment by skilled operators is economically infeasible for smaller systems. No reliable automated control system has ever been developed for activated sludge facilities because they have defied attempts to model mathematically. An approach to the treatment of effluent, which could be simply modeled and automated would be beneficial.

Remedial treatment by physico-chemical means offer some possible recourse. Yet, even though a large number of these remedial treatments have been seriously developed, coming under the heading of “tertiary treatment,” none has found deep-seated acceptance in the field. Generally speaking, the cost and complexity of these remedial treatments has prevented their widespread utilization. On closer scrutiny, two relevant facts concerning these remedial treatments become apparent. First, it is always a single unit operation as treatment for a single pollutional species. Second, these single unit operations are always borrowed from elsewhere in technology and refitted to the wastewater discipline. Complete treatment would necessarily mean a sequence of treatment steps, expanding the complexity and cost of operations beyond practicable limits. Examples of treatments so fitting this characterization are ion exchange for nitrate removal and adsorption using activated carbon.

The idea of a unit operation that deals simultaneously with all significant pollutional components, and/or a unit operation for wastewater treatment invented on an ad hoc basis, is heretofore unreported. The present invention, it is predicated, is an all-encompassing tertiary treatment for effluent from conventional secondary treatment, having been developed from basic chemical science, and expressly for this purpose.

Importantly, because the relevant methodology develops from basic chemical principles rather than operational gimmickry, powerful purificational transformations develop that are so general in scope as to allow its use in the treatment of other CAM.

The effluent from the aerobic bacterial treatment of sanitary wastewater contains three principal material components, which by themselves constitute the shortcomings of this methodology. Phosphates are not removed, nor is nitrogen as ammonia, the latter merely being transformed to nitrates, and microorganisms and other colloidal matter from secondary digestion are all entrained therein. In addition to these methodological problems, there are a multitude of incidental problems, such as toxic loading, temperature depression, and operator errors, which can have serious effects. Also, upsets to treatment by toxic chemicals, which can kill-off the bacterial colony, are particularly problematic as the re-growth of the colony may take days.

### Objects and Advantages

Accordingly, it is the object of the present invention to provide a device and method that employs electrolytic technology as a wastewater treatment that treats the three principal pollutional components of effluent from aerobic biological treatment that develop from that methodology, phosphates, nitrate, and bacterial and colloidal carry-over.

It is a further object of the present invention to favorably alter the surface characteristics of any supernatant biosolids from the aerobic bacterial treatment of wastewater, so that these biosolids can be processed in a more forthright manner, and to lower the infectious thereof.

It is a further object of the present invention to provide a device and method which has the capacity to treat the pollutional components which might accrue from incidental upsets to the aerobic bacterial treatment caused by, for example, operator error, toxic chemical loading, temperature depression or excessive nutrient loadings.

It is a further object of the present invention to provide a device that treats wastewater from aerobic bacterial treatment that is capable of automated operation, which will satisfactorily self-regulate its operation, without the need for intervention by a human operator.

It is still the object of the present invention to provide a device and method, which operates without the substantial intervention of chemical agents (other than alkaline earth carbonates), since these can only, wholly or in part, add to the mass of solids harvested from the effluent, or be entrained in the final effluent. With the treatment of drinking water supplies, this capability is of transcending importance.

It is a further object of the present invention to provide a device and method that substantially reduces the detention time for tertiary treatment, also lowering the land area requirement for so doing.

It is a further object of the present invention to provide a device and method that treats CAM without the generation of side streams, which would have to be treated apart from the influent stream, thereby complicating the operational sequence of a POTW.

The present invention possesses other objects and advantages, especially as it concerns other CAM, such as industrial process wastes and swimming pool contents.

Other particular characteristics and features of the device and method will become apparent as this specification continues.

### SUMMARY OF THE INVENTION

The invention described herein provides an all-encompassing wastewater treatment and disposal system, well suited to application after aerobic bacterial treatment of sanitary wastewater and for the treatment of other CAM. The basic principles are as follows:

Wastewater containing sanitary wastes is committed to conventional primary settling and then aerobic bacterial treatment, followed by partial clarification through settling.

The supernatant liquid therefrom is freely flowed into the cathode chamber of an electrolytic cell.

The chemical composition of the cathode is chosen to produce the following highly sought-after chemical transformations: nitrate into nitrogen gas, the precipitation of orthophosphate ion in the form of its alkaline earth salts, the agglomeration of colloidal, suspended, and soluble organic matter in such a manner as to render the latter filterable and sterile, so generating an aqueous catholyte slurry of these precipitated and agglomerated materials which is easily filterable. Cathode and anode compartments must be separated so that antagonistic chemical processes are isolated from each other, this while maintaining electrolytic conductivity. The cell dividing membrane must therefore be ion permeable. It must be of, as well, be of sufficiently fine porosity to restrict electro-osmotic transference from anode to cathode chamber. PTFE membranes of similar porosity (ca. 0.50 micron) to those used in the filtration apparatus serve this purpose well.

Direct electric current is applied to the electrodes sufficient to raise the pH of the catholyte to the desired level, this by the electrolysis of water to produce hydroxyl ions.

The pH is measured electrometrically, the probe being positioned at the exit port of the cathode chamber. The signal from the pH measuring circuit is electrically connected to a controlling device that throttles the DC power to the cell, maintaining the pH to within set limits. For reasons explained below, this value is chosen at pH 11.3+/−0.3.

Spent catholyte is passed into a membrane filter whose physical and mechanical characteristics are chosen to meet the strictures of the methodology. Back-pulse filtration is capable of the necessary fluid handling demands, namely a feed of low solids content to high liquid volume ratios. The filter medium is chosen as PTFE of 0.45 micron porosity. This type of filter medium seems to work synergistically with the electrolytic cell, in that its ability to separate the agglomerated particles produced in the cathode chamber exceeds the degree of separation observed with other filter media. The possibility that some sort of charge-charge interaction between the particulate matter in the spent catholyte suspension and the filter surface exists suggests itself, for the quality of filtration hereby achieved is beyond what is achieved in typical applications. The agglomerated matter will contain residues of bacterial cells that have been denatured by the elevated pH of the catholyte, organic matter of high molecular weight, alkaline earth phosphates, magnesium ammonium phosphate, and heavy metal hydrous oxides. This agglomerated mass possesses none of the problematic characteristics associated with ordinary biosolids (sludge). It may be pressure filtered with ease and dries directly in air to a residue of only 20% moisture content.

The filter permeate is then fed into the anode chamber. This analyte feed has low concentrations of phosphate and nitrate ions, and minimal presence of suspended colloidal matter. Ammonia, that has not been nitrified in the prior aerobic bacterial digestion and that has not been precipitated as magnesium ammonium phosphate in the cathode chamber, will be present in this feed, along with soluble, low molecular weight organic species. This soluble organic matter is refractory to the agglomeration process, but is susceptible to electro-oxidation at the anode. In order to carry out this electro-oxidation, electrodes with an electrosorptive capability are called for. Anodes of this type are commercially available, containing iridium oxide compositions and operating at low current densities. Electro-oxidation of ammonia through chloramines intermediates, however, requires anodes of high current density and with little electrosorptive capability. The conditions for oxidation of soluble carbonaceous material are then inimical to those for the oxidation of ammonia. In order to deal with the problematic situation where both ammonia and low molecular weight organic matter are co-present, it would be necessary to configure an anode arrangement containing both types, but in relative proportion to the ratio of ammonia to soluble organic matter.

There is a net pH imbalance to the electrolytic cell as it operates in the manner described above. Although hydroxyl ion is produced in exact amount at the cathode as is hydrogen ion is at the anode, hydroxyl ion is retired from solution by a number of chemical processes taking place in the cathode chamber (calcium carbonate, heavy metal hydrous oxide, and alkaline earth phosphate formation). The formation of insoluble compositions at the cathode then leads to an overall excess of hydrogen ions since there is no corresponding retirement of hydrogen ions in the anode chamber. The operation of the cell will then produce a cell effluent that falls well below that of the influent. For example, effluent pH values in the range of 2 to 3 pH are so encountered, when the cell influent has pH values in the neutral range.

When the cell influent is low in alkaline earth concentrations, current will then be carried by ionic species, such as phosphate, nitrate, and detergent anions, this from cathode chamber to anode chamber. This type of conductive transference is problematic in that these species are pollutional in nature, and are escaping agglomerative harvesting by so doing. Since these species are anionic, their transference may be curtailed by interposing a cation selective membrane in tandem with the existing separation membrane. Membranes of this type are widely used in electrochemical technology, an example being Nafion, a fluorosulfonate type made by DuPont. In so disposing a cation selective membrane, the only means by which adequate conductivity can be effected is by the passage of cations, in this case, from anode compartment to cathode compartment. This transference is dictated by nature in order to maintain charge balance within the system. Hydrogen ions are the dominant cationic species in the anode compartment, together with their extraordinary ionic mobility, would lead to transference into the cathode compartment that would severely diminish the hydroxyl ion concentration that is essential to the cathode compartment chemistry.

By the addition of calcium and/or magnesium carbonates to the anode compartment, several problematic process considerations are nicely put to rest. Hereby the depressed pH of the effluent is raised to or near the neutral point by dissolution of these carbonates. Alkaline earth cations then substituting for the hydrogen ions, migrate to the cathode chamber and enhance the agglomerative process. This agglomerative process requires that the elevation of the pH in the cathode compartment be maximized. Hydroxyl ion plays a significant role in this process, apparently because of its polarizability to the surfaces of the colloids present. The higher the pH, the more effectively the agglomeration of the colloidal material is effected. For a system of this sort, this pH is on the order of 11.5. It is not possible to attain pH values above this level as there is always migration of hydrogen ion into the cathode chamber, even though the hydrogen ion concentration is suppressed by the presence of alkaline earth carbonates.

Adequate conductivity is assured, migration of anionic species is further suppressed, and agglomeration at the cathode is enhanced. Since the dissolution of these carbonates is self-limited by acid-base equilibria, no sensing/dispensing system is required, and there can be no excessive concentrations of alkaline earths in the effluent.

The devices and processes used to provide the aforementioned system can be made to yield high reliability by using direct physico-chemical means for treating the settled, but unfiltered slurry out of aerobic bacterial treatment at typical POTWs. The qualities of the liquid and solid products can be made to exceed stringent prevailing legal and regulatory standards for discharge, and even approach standards for reuse of the liquid product.

The apparatus can be designed to be fail-safe, i.e., to stop the throughput of untreated CAM under conditions of equipment failure. The system can readily be automated, with self-diagnostic capability, eliminating the need for costly personnel. Importantly, the system is compact, given that the detention times are on the order of twenty minutes. The area required (footprint) for this equipment is on the order of 10% of that required for the necessary combination of tertiary treatments. Finally, the treatment consumes little electrical energy, e.g., only about as much as that required by UV disinfection alone.

### DESCRIPTION OF THE PREFERRED EMBODIMENTS

The preferred embodiments presented in this disclosure may be grouped into two categories; first, those relating to physico-chemical aspects, and second, those related to engineering aspects.

Physico-Chemically Related Aspects

Although the electro-reduction of the nitrate ion has been the subject of a number of investigations that have been reported in the chemical literature, no serious attempt to electro-reduce the nitrate ion on massive scale has been reported. Furthermore, even the laboratory scale processes so reported were not highly efficient. The present invention employs an electrolytic cell containing a cathode formed from one or more valve metals, or alloys thereof, so pretreated by augmentative surface oxidation, in order to establish domains of high positive charge thereat. This condition of valve metal ions of high positive charge, present at the interface of cathode and solution, has shown remarkable ability to attract and agglomerate negative colloidal matter under the conditions of electrolysis. That other negative species could also be expected to be attracted to these electropositive surface domains should not be surprising. Since the cathode surface is a domain of strong reduction potential and the nitrate ion is a species of strong oxidizing potential, it is not surprising that reduction of nitrate ion occurs, further, that this reduction stops at the formation of nitrogen gas, rather than proceeding to ammonia, is noteworthy. That nitrate ion is quantitatively electro-reduced at the cathode, and in a much more efficient manner than reported in other studies is also noteworthy. Indeed, the ease by which this electro-reduction takes place may be interpreted as further proof of the electrostatic mechanism that serves as the basis of this invention.

The nitrate ion is an important pollutional species in wastewater after aerobic biological digestion, and a serious contaminant in drinking water supplies that have been compromised by infiltration of wastes. Chemical analysis of wastewater containing the nitrate ion, when subjected to passage through the cathode chamber of the electrolytic cell, is reduced to nitrogen gas. Further, the inclusion of nitrate ion in the influent has no apparent effect on the other critical cathode processes the agglomeration of colloidal matter, and the precipitation of alkaline earth phosphates. Nor is there any alteration of the relationship between current passed and pH elevation within the cathode compartment. It must, therefore, be concluded that the overall (stoichiometric) equation for the nitrate reduction is:

6H₂O+1Oe⁻+2NO₃⁻=N_{2(g)}+12OH⁻ (1)

(The above equation allows the calculation between current passed and nitrate removed, and given a nitrate ion specific electrode, could form the basis for the construction of an automated system, at least for nitrate removal. While no such direct relationship can directly be written for the agglomeration of colloids, this function of the cell being only learned by experience.) The reduction does proceed to nitrogen gas and not beyond because no nitrogen containing species, such as nitrite, ammonia, or hydrazine can be detected in the spent catholyte. This ability to so remove nitrate ion is a major innovation in that it co-occurs with the agglomeration of colloidal matter, and without any further demands on energy consumption.

The problem of migration of anionic species (nitrate, phosphate, anionic detergents) from the cathode compartment to the anode compartment was resolved by a two-stage innovation. First, a cation selective membrane was emplaced in between the compartments of the cell, mounted to the same framing arrangement as the membrane that restricts electro-osmotic migration, but to the anode side of the flow-restrictive membrane. With the transference of anionic species now restricted and having no role in sustaining electrical conductivity of the system, the only means by which electrolytic conductivity can take place is by the migration of cations out of the anode chamber and into the cathode chamber. Since hydrogen ions are being created at the anode, and become the preponderant cationic species within the system, it is this species which will migrate most importantly, especially so given their transcendent ionic mobility. This transference of hydrogen ion is inimical to the alkalinity needed to assist in the agglomeration of colloidal matter. Further, the retirement of hydroxyl ions at the cathode (described above) leaves the final effluent in an unacceptably acid condition.

In order to diminish the migration of hydrogen ions across the membrane and into the cathode chamber, while at the same time elevating the pH of the final effluent, and ensuring an adequate supply of alkaline earth cations to the cathode chamber, calcium and/or magnesium carbonates can be added to the analyte. These carbonates are only slightly soluble in water but will dissolve in acidic aqueous media to neutralize acidity, without being able to elevate the pH above the neutral point.

MCO₃+2H⁺M²⁺+CO_{2(g)}+H2O (M=Ca or Mg) (2)

The advantages accruing by this method of acid neutralization summarized as:

1. Raising on pH of final effluent to neutral, but not beyond

2. Supply of alkaline earths to cathode compartment

3. Self-dispensing, no need for dispensing equipment.

It should be noted that alkaline earth cations do not emerge in the final effluent. Instead they migrate to the cathode compartment, whence they will precipitate and be harvested by the filter.

While the chemical composition of secondary effluents from POTWs is remarkably consistent, compared to the variation is influent composition, there is variation in the nitrogenous compositions emerging from these facilities. Depending on the length of aeration, the nitrogen will emerge as ammonia, nitrate ion, or any mixture of these species. IS easily removes nitrate ion. via the chemical reaction represented by equation (2). The presence of ammonia in the final effluent would require the deployment of high current density anodes, preferably of polished platinized wire, this so as to oxidize the ammonia to nitrogen gas through chloramine intermediates. The requirement to oxidize ammonia would compromise the ability of the system to oxidize low molecular weight organic species, this owing to the needed replacement of dimensionally-stable anodes of the doped oxide type with those of polished platinum.

It has been found that on extended and continuous operation of the cell that a coating of calcium carbonate can sometimes form on the cathode surface. The effect of this formation is highly detrimental to the electro-catalytic action of the cathode surface. It has been a simple matter to overcome, however. Simply by incorporating a periodic reverse of the polarity of the cell, i.e., making the cathode momentarily anodic, sufficient interfacial acidity can be built to cause the dissolution of the carbonate film to relieve the system of this problem. The frequency and duration of this correction would have to be experimentally derived, this owing to the formidable combination of variations possible under the sun.

### Chemical Aspects

The electrolytic cell of this disclosure is now committed to treating a variety of CAM (contaminated aqueous media). This includes sanitary wastewater, partially treated sanitary wastewater, drinking water supplies, cooling tower water, swimming pool contents, agricultural and livestock-raising effluents, and certain industrial and food processing wastewaters. The variational aspects of these CAM now are a consideration, with the resulting design of the cell having taken on more complexity. Most importantly, given the variation in composition of the nitrogenous component between drinking water supplies and well-aerated sanitary wastewater on the one hand (nitrate containing), and anaerobic feeds, on the other hand (ammonia containing), the anode composition must be harmonized with the treatment requirements posed by these two categories of CAM. Where ammonia is the pollutant, the anode material would be such that would be capable of producing chloramines intermediates for the degradation of the ammonia. Where ammonia is not present, the composition of the anodes would be such that would be capable of oxidation of other polluting species typically carbonaceous compositions. Anodes of the dimensionally stable type, usually doped with iridium oxide, are suited to this purpose. Where nitrates are the sole nitrogenous species present in the CAM, there is no consideration of anode specification necessary for this purpose, as nitrates are reduced at the cathode.

However, where both ammonia and nitrate are co-present, such as is the case when the CAM feed consists of sanitary wastewater that has received something less than a period of extended aeration, a cell with mixed anodes is called for. Since, in the case of a CAM with ammonia content that has only been diminished by partial nitrification, but where some ammonia is not oxidized, a limited capacity to degrade ammonia would have to be retained. The nitrogenous balance between ammonia and nitrate would then determine the ratio to be arrived at for the ammonia destruct and high-surface-area electrodes.

The problem of migration of the pollutants phosphate, nitrate, and anionic organic matter was resolved by avoiding the simplistic placement of a cation selective membrane in tandem with the existing fluid-flow restricting membrane, which sets up a problem which checkmates the functionality of the system. By incorporating a cation exchange membrane within the cell, the flow of anions to the anode chamber is indeed restricted, which was sought. However, by so doing, the only means of charge neutralization that the system has available to itself is the migration of hydrogen ion to the cathode side. This transfer would seriously reduce the concentration of hydroxyl ions needed to carry out the critical colloid agglomeration. An important idea was reducing the concentration of hydrogen ions by replacing them with other cations.

Since this problem originally manifested itself only when there were low concentrations of alkaline earths in the CAM, and there are the most severe limitations imposed on the addition of chemical agents to the process, the idea was to introduce alkaline earth carbonates to the anode chamber. This would simultaneously raise the pH of the discharge, stabilize the high pH needed at the cathode, and ensure a sufficiency of concentration of alkaline earths at the cathode. There are virtually no chemicals added. Alkaline earths are present in varying concentrations in all natural surface and subsurface waters. Further, the bulk of the transferred alkaline earths are in fact removed as part of the agglomeration process. This chemical addition is then the, in all probability most innocuous chemical addition under the sun.

### Engineering Design Aspects

The development of a practicable design presented daunting problems, given the considerations presented in the present-day world of commerce. Capital and operating cost of the system, including health liability to workers, was the great force driving these considerations. The proper response to these considerations was the echelon/insert system.

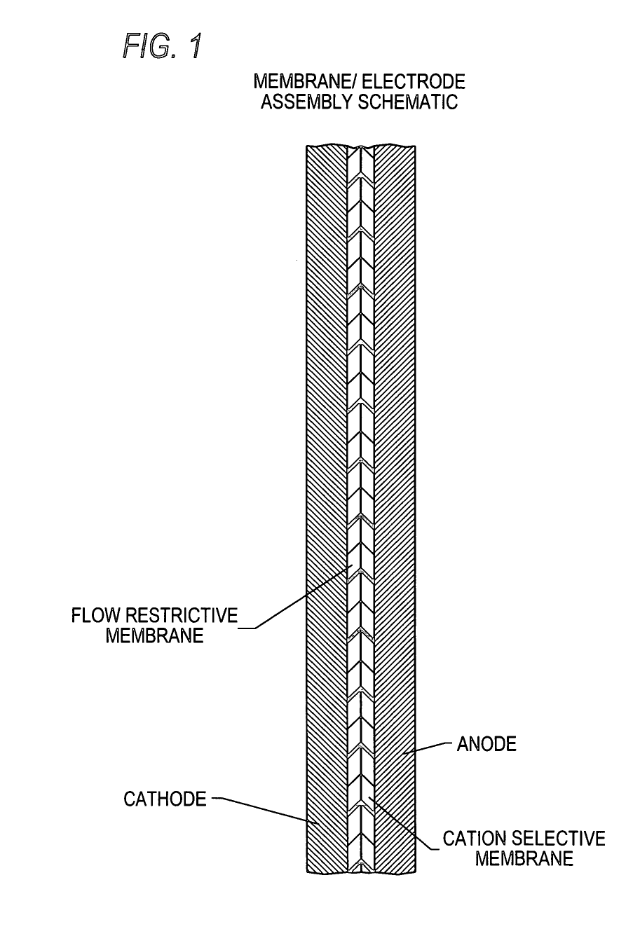

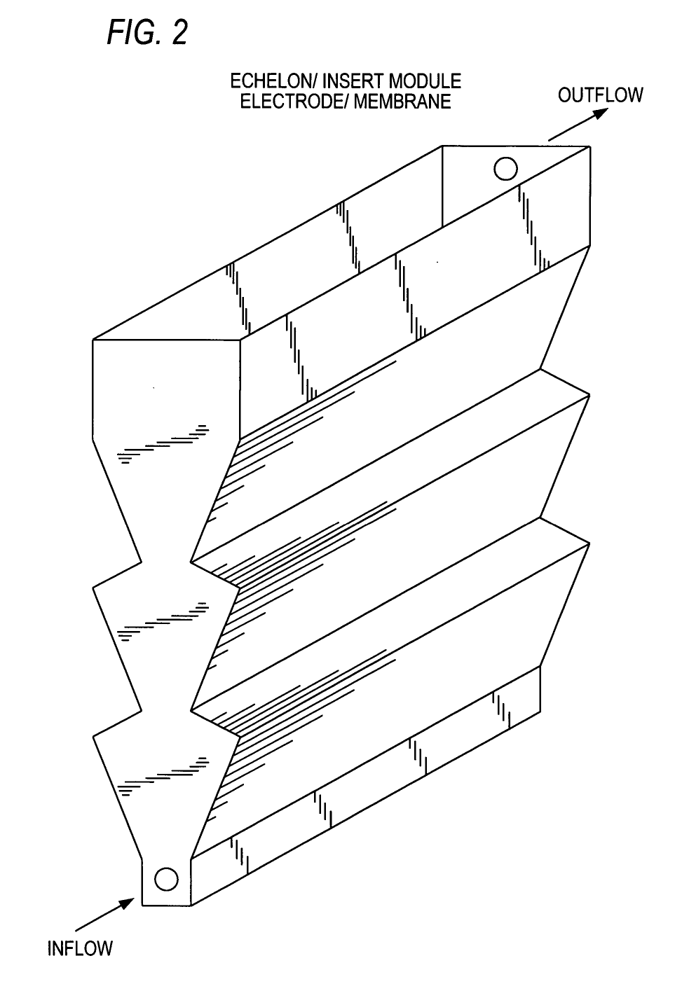

The primary practical consideration for the system is cost of operation. The cost of operation is the cost of electricity, making the electrical resistance of the system the prime consideration. Given the fixed electrical conductivities of the feed CAM, the geometry of a design that minimizes the distance between the electrodes becomes the first task. Then, the design must be normalized to conform with the fluid-handling maxim that all the liquid must pass over the surface of the cathode. The configuration of the electrode/membrane assembly is then that given in accompanying FIG. 1. and the echelon/insert module is shown in accompanying FIG. 2. The modules would then be positioned into existing holding tanks at a typical treatment facility for drinking water or wastewater. This modular concept is often used in water treatment when it is practicable only to produce basic units of modest capacity. (Reverse osmosis facilities use this principle because the size of the RO membranes is limited)

Influent CAM would be directed by a piping system to the lower interior of the modules. Convectively driven flow over the cathode plates would develop with the application of the electrical potential across the electrodes. Agglomeration of colloids, precipitation of phosphates, and the reductive degradation of nitrate ion would occur. Outflow at the top of the insert module would occur, and into a holding tank. Some settling will occur in the holding tank and so minimize the solids loading on the back-pulse filter that follows this holding tank. Delivery of the filtrate is to the holding tank that envelops the aggregated modular array, where the filtrate is exposed to the anode arrangement peculiar to the treatment requirements of the CAM and receives the predetermined anodic treatment. A means of delivery of alkaline earth carbonate to this holding tank is provided. This may be done simply by hanging water permeable sacks of limestone chips therein. These sacks would have to be replaced on a scheduled basis so as to ensure conformity with the electrochemical requirements discussed above. Importantly, no chemical metering system would be required. At this point in the sequence, the liquid is dischargeable.

The insert aspect of the echelon/insert system allows the modules to be serviced by first removing the from the holding tank, thereby eliminating the need to have personnel enter into an environment which may expose them to pathogenic materials.

What is claimed is:

1. A drinking water process providing a fully treated water comprising:
a. passing raw water into a specially treated cathode of an electrolytic cell water treatment system aggregating colloids of turbidity and color, removing phosphorous, removing nitrate nitrogen and microbial life;
b. passing the special cathode treated fluid into a holding chamber for a set time to provide additional time for microbial kill at the high pH;
c. passing the special cathode treated fluid from the holding zone to a microporous filter;
d. passing the microporous filter effluent to an anodic electrode part of the electrolytic cell where oxidation products are produced;
e. passing the anodic electrode effluent to a holding zone for a set amount of time with the anodic oxidation products;
f. passing the effluent from the anode holding zone to the drinking water distribution system with removal of turbidity and color, phosphorous, nitrate nitrogen and microbial life and addition of residual chlorine.

2. The drinking water process according to claim 1 comprising: the addition of an anodic cell treatment at low pH allowing the oxidation by anodic oxidants of the microbial life and organic materials.

3. The drinking water process according to claim 2 comprising: the zone of anodic oxiation at low pH for a set holding period.

4. The drinking water process according to claim 3 comprising: where the anodic cell effluent after low pH treatment is passed to a cathodic zone for pH neutralization of the anodically treated water.

5. The drinking water process according to claim 1 comprising: a selective cation membrane in addition the existing membrane separating the cathode and anode zones.

6. The drinking water process according to claim 5 comprising: an addition of alkaline earth cations to the anodic zone to neutralize acidity and supply alkaline earth ions to the special cathodic zone where the alkaline earth ions are precipitated at the high pH.

7. A drinking water process providing a fully treated water comprising: a periodic reversal of the polarity of the electrolytic cell to dissolve the carbonate film on the special cathode surface.

8. The drinking water process according to claim 7 comprising: a periodic addition of acid to dissolve the carbonate film on to the special cathode electrode.

9. The drinking water process according to claim 1 comprising: a specially treated cathode electrode based on a valve metal or alloy there of treatment.

10. The drinking water process according to claim 1 comprising: an anodic zone oxidant level to oxidize ammonia nitrogen to nitrogen gases.

11. The drinking water process according to claim 1 comprising: a specially treated cathode to reduce nitrate nitrogen to nitrogen gas.

12. The drinking water process providing a fully treated wastewater comprising: a process wherein one electrolytic cell is placed on top of another electrolytic cell.

13. The drinking water process according to claim 1 comprising: a series of electrolytic cells built upward from the bottom electrolytic cell.

14. The drinking water process according to claim 1 comprising: the use of a back-pulse microporous filter for the filtering method.

15. The drinking water process according to claim 1 comprising: an anodic electrode of high current density for ammonia removal.

16. The drinking water process according to claim 1 comprising: an anodic electrode of electro-sorptive capacity or low current density for soluble organic oxidation.

17. The drinking water process according to claim 1 comprising: both an anodic high density electrode for ammonia removal and an anodic low density electrode for organic oxidation.

18. A pollutant removal process providing a fully treated wastewater comprising:
a. passing secondary treated wastewater effluent into a specially treated cathode of an electrolytic cell wastewater treatment system aggregating and filtering colloids of turbidity and color, removing phosphorous, nitrate nitrogen and microbial life.
b. passing the specially treated cathode effluent to a specific holding zone for a specific holding time at high pH;
c. passing the holding zone effluent to a microporous filter
d. passing the effluent of the microporous filter to an anoxic zone where anodic oxidants are produced.
e. passing the effluent of the anodic zone to a anodic holding zone where the anodic oxidants oxidize ammonia nitrogen and organics.
f. passing the effluent of the anoxic zone to the receiving water or to water reuse.

19. The pollution removal process according to claim 18 comprising: the addition of an anodic cell treatment at low pH allowing the oxidation by anodic oxidants of the microbial life and organic materials.

20. The pollution removal process according to claim 19 comprising: the zone of anodic oxiation at low pH for a set holding period.

21. The pollution removal process according to claim 18 comprising: where the anodic cell effluent after low pH treatment is passed to a cathodic zone for pH neutralization of the anodically treated water.

22. The pollution removal process according to claim 18 comprising: a selective cation membrane in addition the existing membrane separating the cathode and anode zones.

23. The pollution removal process according to claim 18 comprising: an addition of alkaline earth cations to the anodic zone to neutralize acidity and supply alkaline earth ions to the special cathodic zone where the alkaline earth ions are precipitated at the high pH.

24. The pollution removal process providing a fully treated wastewater comprising: a periodic reversal of the polarity of the electrolytic cell to dissolve the carbonate film on the special cathode surface.

25. The pollution removal process according to claim 24 comprising: a periodic addition of acid to dissolve the carbonate film on to the special cathode electrode.

26. The pollution removal process according to claim 18 comprising: a specially treated cathode electrode based on a valve metal or alloy thereof treatment.

27. The pollution removal process according to claim 18 comprising: an anodic zone oxidant level to oxidize ammonia nitrogen to nitrogen gases.

28. The pollution removal process according to claim 18 comprising: a specially treated cathode to reduce nitrate nitrogen to nitrogen gas.

29. The pollution removal process providing a fully treated wastewater comprising: a process wherein one electrolytic cell is placed on top of another electrolytic cell.

30. The pollution removal process according to claim 29 comprising: a series of electrolytic cells built upward from the bottom electrolytic cell.

31. The pollution removal process according to claim 18 comprising: the use of a back-pulse microporous filter for the filtering method.

32. The pollution removal process according to claim 18 comprising: an anodic electrode of high current density for ammonia removal.

33. The pollution removal process according to claim 18 comprising: an anodic electrode of electro-sorptive capacity or a anodic low current density for soluble organic oxidation.

34. The pollution removal process according to claim 18 comprising: both an anodic high density electrode for ammonia removal and an anodic low density electrode for organic oxidation.

35. The pretreatment of water, primary treated wastewater and secondary treated wastewater to remove colloids according to processes in claim 1 and claim 18 respectively before treatment by microporous membranes such as ultrafilters, nanofilters, and reverse osmosis membranes.

36. The pretreatment of primary treated wastewater and secondary treated wastewater to remove colloids according to processes in claim 1 and claim 18 respectively to improve the rate of biological oxidation.

37. The pretreatment of any contaminated fluid to remove colloids according to processes in claim 1 and claim 18.

38. The treatment of water for removal of nitrate-N according to claim 1.

39. A drinking water process according to claim 1 comprising the treatment of drinking water to remove colloids before disinfection to improve the disinfection efficiency by oxidants such as chlorine and ozone and improve the disinfection and operation efficiency of radiation units such as ultraviolet (UV) light.

40. A drinking water process according to claim 1 comprising the treatment of drinking water to remove colloids before passing the liquid through an electrolytic disinfection unit.

41. A drinking water process according to claim 1 comprising the treatment of drinking water to remove colloids before disinfection to improve the disinfection efficiency by toxic chemical agents such as phenol, heavy metals such as cadmium, pH such as high hydrogen ions and/or low hydrogen ions, temperature such as high degrees centigrade, and radiation such as electromagnetic, acoustic and particle.

42. A drinking water process according to claim 1 comprising the treatment of drinking water to remove colloids containing toxic matter such as endocrine disrupter biochemicals.

43. A drinking water process according to claim 1 comprising the treatment of drinking water to remove colloids containing only inorganic or only organic constituents.

44. A drinking water process according to claim 1 comprising the treatment of drinking water to remove colloids containing both inorganic and organic constituents.

45. The pollution removal process according to claim 18 comprising the treatment of treated wastewater to remove colloids before disinfection to improve the disinfection efficiency by oxidants such as chlorine and ozone and improve the disinfection and operation efficiency of radiation units such as ultraviolet (UV) light.

46. The pollution removal process according to claim 18 comprising the treatment of treated wastewater to remove colloids before passing the liquid through an electrolytic disinfection unit.

47. The pollution removal process according to claim 18 comprising the treatment of treated wastewater to remove colloids before disinfection to improve the disinfection efficiency by toxic chemical agents such as phenol, heavy metals such as cadmium, pH such as high hydrogen ions and/or low hydrogen ions, temperature such as high degrees centigrade, and radiation such as electromagnetic, acoustic and particle.

48. The pollution removal process according to claim 18 comprising the treatment of treated wastewater to remove colloids containing toxic matter such as endocrine disrupter biochemicals.

49. The pollution removal process according to claim 18 comprising the treatment of treated wastewater to remove colloids containing only inorganic or only organic constituents.

50. The pollution removal process according to claim 18 comprising the treatment of treated wastewater to remove colloids containing both inorganic and organic constituents
